(19) United States
(12) Patent Application Publication
(10) Pub. No.: US 2003/0022946 A1
(43) Pub. Date: Jan. 30, 2003

(54) Separating an emulsion into an aqueous phase containing a reusable anionic surfactant

(76) Inventors: James H Bush, Mentor, OH (US); Robert N Jones, Mentor, OH (US); Stuart L Bartley, Wickliffe, OH (US)

Correspondence Address: The Lubrizol Corporation, Patent Administration, Mail Drop 022B, 29400 Lakeland Boulevard, Wickliffe, OH, 44092-2298, US

(21) Appl. No.: 10/204,521

(22) PCT Filed: Mar. 5, 2001
(86) PCT No.: PCT/US01/06996

(51) Int. Cl. B01F 3/08

(52) U.S. Cl. 516/38

(57) ABSTRACT

A process for separating a hydrophobic hydrocarbon chemical from an aqueous emulsion and recycling the majority of the water, co-solvents, salts, and the emulsifier is set forth. A preferred emulsifier is a salt of a carboxylic acid, phosphoric acid or sulfonic acid having an amine in the hydrophobic portion of the emulsifier, said amine being capable of being protonated to change (increase) the water solubility of the entire emulsifier molecule. The process is useful for soil remediation by extraction in that it facilitates the recycling of the water and emulsifier dramatically reducing the amount of water and emulsifier used in remediating a site. A method for remediating contaminated soil using the process is also set forth.

### FIELD OF THE INVENTION

This invention relates a process to easily separate and recycle emulsifiers and water from emulsions of hydrophobic organic chemicals and water. One embodiment is separating the emulsifiers and water from the organic phase in soil remediation, where the organic contaminants are washed from the soil with emulsifiers and water. The emulsifiers useful in this process are characterized by having a basic nitrogen atom (internal amine), which can be protonated under acid conditions to increase the hydrophilicity of the emulsifier. A preferred emulsifier for the process is a reaction product of a salt of an acrylamidoalkanesulfonic acid with an amine. Another emulsifier is a reaction product of a salt of an acrylamidoalkanephosphonic acid with an amine.

### BACKGROUND OF THE INVENTION

Emulsions of a water phase, an organic phase and an emulsifier have found a variety of uses in our society (soil remediation, metal working fluids, etc). When the emulsions are no longer useful for their intended purpose they can be broken into separate water phases and organic phases by 1) reducing the hydrophilicity of an anionic or cationic surfactant (e.g. acidifying the salt of a carboxylic acid or de-protonating a cationic surfactant) or by changing the aqueous phase electrolyte concentration for an anionic or cationic surfactant (promoting coalescence of the organic phase). After these emulsion breaking processes a significant portion of the emulsifier goes with the organic phase to be recycled or disposed. The water phase is usually partially purified and discarded. In some processes where the organic phase is to be discarded or replaced with a new organic phase, it would be desirable if a majority of the emulsifier could be transferred to the water phase rather than the organic phase.

Soil pollution is a major problem, which can be remediated by removing the contaminants or preventing their migration from their present location. Removal can be accomplished by extraction with an organic solvent or with water and emulsifiers. After extraction the removed contaminants must be separated from the extraction fluid and recycled, converted to nonhazardous materials, or safely stored. Current soil remediation processes with water and emulsifiers are costly due to the fact that the majority of the emulsifiers used in the process are disposed with the contaminant. The emulsions of water, emulsifier and contaminant are separated by breaking the emulsion into an organic phase and a water phase. The majority of the emulsifiers is conventionally in the organic phase and not easily separated therefrom for subsequent reuse on the same site.

U.S. Pat. No. 5,725,470 (Lazarowitz et al., Mar. 10, 1998) discloses a process for the remediation of soil containing volatile organic compounds which comprises the steps of: (1) forming an emulsifier comprising: (a) from about 70 to about 99% by weight of a sugar surfactant selected from the group consisting of an alkyl polyglycoside, a glucamide, and mixtures thereof; and (b) from about 1 to about 30% by weight of a nonionic surfactant, other than said sugar surfactant which, when combined with said sugar surfactant, provides a hydrophilic-lipophilic balance of from about 8.0 to about 13.0; (2) mixing said emulsifier with said unwanted contaminants to form a stable emulsion; and (3) removing said stable emulsion from said soil.

### SUMMARY OF THE INVENTION

Disclosed is a process for breaking an emulsion of water and an hydrophobic organic phase where the majority of the emulsifier remains in the water phase and thereafter reusing the water phase and the emulsifier therein. A preferred emulsifier comprises a salt of a phosphonic, phosphoric, carboxylic, sulfonic, disulfonic or sulfuric acid, wherein the salt of said acid includes a protonatable amine in the hydrophobic part of the emulsifier. A preferred process includes acidifying the emulsion (which protonates the amine and breaks the emulsion), separating the organic phase from the water phase, adjusting the pH (typically above 7) to form the original emulsifier, and adding a new organic phase to regenerate the emulsion. This process can be repeated multiple times. Optionally additional water, emulsifier, or other additives can be added to the water phase before the organic phase is added to form the emulsion to optimize the characteristics of the final emulsion. The organic phase can be a desirable component of the emulsion (e.g. a functional additive) or it can be a soil contaminant that is added as part of a soil remediation process.

Also disclosed is a method for remediating soil which is contaminated by one or more hydrophobic organic chemicals, comprising: contacting the contaminated soil with an aqueous composition comprising a salt of a carboxylic, sulfonic, disulfonic, sulfuric, phosphonic, or phosphoric acid having a protonatable amine in the hydrophobic portion of said salt, whereby at least a portion of said hydrophobic organic chemical becomes associated with said aqueous composition in the form of an emulsion, thereafter separating said emulsion from said soil and adjusting the pH of said emulsion downward until the amine of said salt is protonated thereby breaking said emulsion, isolating said hydrophobic organic chemical separate from said water and said salt of the acid, thereafter adjusting the pH of the water and salt of the acid (typically above 7) to reverse the protonation of said amine and regenerate the non-protonated salt, and reusing the water and said salt of the acid to contact the contaminated soil whereby at least a portion of said hydrophobic organic chemical of said contaminated soil becomes associated with said water and said salt of the acid.

Preferred emulsifiers include a surfactant prepared by reacting a sulfate, sulfonate, disulfonate, phosphonate, phosphate, or carboxylate of the formula

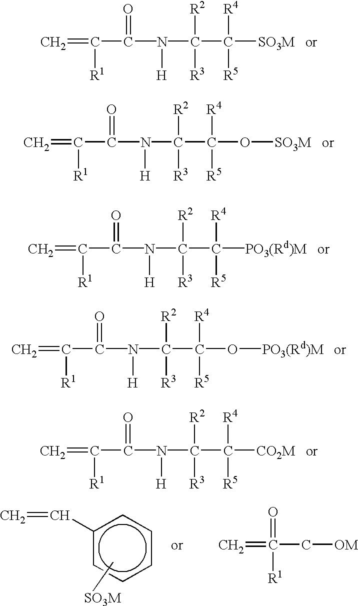

with an amine of the formula

R⁶R⁷NH or R⁸(NH₂)ₙ

wherein R¹ is hydrogen, methyl or ethyl; R² is hydrogen or an alkyl group containing up to 18 carbon atoms, more preferably an alkyl of 1 to 4 carbon atoms; each of R³, R⁴ and R⁵ is individually hydrogen an alkyl group containing up to 7 carbon atoms or an alkylene sulfonate group of 1 to 4 carbon atoms, more preferably a hydrogen or an alkyl of 1 to 4 carbon atoms; R^{d} is H or an alkyl of 1 to 4 carbon atoms; and M is an alkali metal, an alkaline earth metal or —NR¹⁰R¹¹R¹² wherein R¹⁰, R¹¹ and R¹² are independently hydrogen or hydrocarbyl groups containing from 1 to 22 carbon atoms or

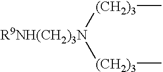

wherein R⁶ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms, or R⁹NH(CH₂)₃— wherein R⁹ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms; R⁷ is —(CH₂)₃NH₂; n is 1 or 2 and when n is 1, R⁸ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms and when n is 2, R⁸ is a hydrocarbylene group containing from 6 to 30.

### DETAILED DESCRIPTION OF THE INVENTION

Practicing the process of the invention involves selecting an emulsion having an emulsifier capable of enhanced water solubility under predefined conditions (e.g. acidic). The emulsifier also needs to be one that can be converted back to its original structure after having been modified to have enhanced water solubility. The anionic emulsifiers having one or more nitrogen atoms in them, wherein the nitrogen atoms can be protonated are particularly well suited for this process, as the nitrogen can be protonated increasing the water solubility of the entire emulsifier. The anionic group (hydrophilic portion of the emulsifier) is desirably a sulfonate, disulfonate, sulfate, carboxylate, phosphate or phosphonate. The sulfonate, disulfonate and phosphonate are preferred due to the fact that emulsifiers based on these groups are less sensitive to pH changes and divalent cations. Thus effective emulsifiers for this process are emulsifiers characterized by having 1 or more anionic groups selected from carboxylates, sulfonate, and phosphonates; a hydrophobic segment having from 8 to 50 carbon atoms, more desirable 8 to 40 carbon atoms and one or more nitrogen atoms in the hydrophobic segment of the emulsifier, wherein the nitrogen atom can be protonate by acidifying the aqueous phase. The hydrophobic segment of the emulsifier can include various heteroatoms such as oxygen, nitrogen hydrogen and carbon. The hydrophobic segment can include alkyl groups, aromatic groups, amide linkages etc. The lower limit on the number of carbon atoms assures a hydrophobic nature to the emulsifier segment, the upper limit on the number of carbon atoms assures that the hydrophobic segment is not too hydrophobic such that the protonation of a single or multiple nitrogen atoms in the hydrophobic segment would have negligible effect on the water solubility of the emulsifier. Desirably the HLB (hydrophile-lipophile balance) of the emulsifier under neutral or basic conditions is from about 10 to about 20 and more desirably from about 12 to about 18. Desirably the HLB under acidic conditions is at least 30.

The process of the invention after isolating an emulsion of a hydrophobic organic chemical, water, and emulsifier involves the sequential steps of acidifying the emulsion to protonate one or more nitrogen atoms in the emulsifier, separating the hydrophobic organic chemical from the water and emulsifier, adjusting the pH of the emulsifier to de-protonate the nitrogen atom(s) of the emulsifier and adding a hydrophobic organic chemical to the recovered water and emulsifier to form an emulsion.

Desirably at least 70, 80, or 90 weight percent of the water in the emulsion can be recovered by this process. Desirably at least 40, 60, or 80 weight percent of the emulsifier can be recovered in the water phase. Desirably the concentration of the hydrophobic organic material in the recovered water and emulsifier has been reduced by at least 50, 70 or 90 weight percent relative to its initial concentration before the process of breaking the emulsion and recovering the aqueous phase and emulsifier. The weight percents given above are for the process in general and it is acknowledged that there may be small portions of emulsion that does not respond as predicted. Further it is acknowledged that while the emulsifier with the protonatable amine group is recovered in high percentages, other emulsifiers used in the emulsion may not be recovered.

In the process of the present invention, the term “soil” is used in a generic sense to refer to the various materials which can be encountered in the earth and which can be the subject of contamination. Soil, therefore, includes rocks, sand, gravel, clays, silt, humus, loess, and other such components, alone or in combination, and including varying amounts of water which may be found in the presence of such components, as is found in the ground. The particular composition of soil varies from location to location in a way which is widely recognized and is well known to those skilled in the art. The particular type of soil for which the present invention is suitable is not particularly limited. For testing and evaluation purposes, a standard soil known as “Canadian River Alluvium,” consisting of 72% sand, 27% silt and clay (on a dry basis), and an organic carbon content of 0.07%, is sometimes employed.

Soil can be contaminated by a variety of exogenous organic materials. The contaminants can be associated with the solid components of the soil or the water component of the soil (i.e., groundwater) or both. These contaminants are often characterized by a greater or lesser degree of hydrophobicity, water insolubility, and sometimes a tendency to sorb to various soil components. These properties make remediation of the soil more difficult. Common contaminants include crude oils, that is, mineral oils, petroleum, solvent or acid treated mineral oils, and oils derived from coal or shale. Synthetic oils can also be contaminants: these include hydrocarbon oils, halo-substituted hydrocarbon oils, alkylene oxide polymers, esters of dicarboxylic acids and polyols, esters of phosphorus-containing acids, polymeric tetrahydrofurans and silicon-based oils. Also included are crude oil fractions and refined hydrocarbons such as gasolines, kerosene, diesel fuel, and fuel oil. Also included are commercial oil-containing compositions, such as motor oils and other lubricants, transmission fluids, and hydraulic fluids.

The general terms used for soil contaminants are NAPL's (non-aqueous phase liquids) and DNAPL's (dense non-aqueous phase liquids). The Environmental Protection Agency (EPA), U.S. Department of Energy (DOE), U.S. Department of Interior (DOI), and U.S. Department of Defense (DOD) have further classified these materials as follows:

1. Non-halogenated volatile organic compounds

2. Halogenated volatile organic compounds

3. Non-halogenated semi-volatile organic compounds

4. Halogenated semi-volatile organic compounds

5. Fuels

Sites where non-halogenated and halogenated volatile organic compounds may be found include burn pits, chemicals manufacturing plants or disposal areas.

A non-exhaustive list of typical non-halogenated volatile organic compounds (excluding fuels and gas phase contaminants) encountered at many sites include the following: n-butanol, 4-methyl-2-pentanone, acetone, acrolein, acrylonitrile, aminobenzene, carbon disulfide, cyclohexane, ethanol, ethyl acetate, ethyl ether, isobutyl alcohol, methanol, methyl ethyl ketone, methyl isobutyl ketone, styrene, tetrahydrofuran and vinyl acetate.

A non-exhaustive list of typical halogenated volatile organic compounds encountered at many sites include the following: 1,1,1,2-tetrachloroethane; 1,1,1-trichloroethane; 1,1,2,2-tetrachloroethane; 1,1,2-trichloroethane; 1,1-dichloroethane; 1,1-dichloroethylene; 1,2-dichloroethane; 1,2-dichloropropane; bromoform; bromo-ethane; carbon tetrachloride; chlorodibromomethane; chloroethane; and chloroform

Sites where non-halogenated and halogenated semi-volatile organic compounds may be found are the same sites as for non-halogenated and halogenated volatile organic compounds, but also includes wood preserving sites.

The foregoing contaminants may be associated with the solid soil particles, with the water component of the soil, or in any combination thereof.

The process of this invention utilizes an aqueous composition comprising a surfactant which can be prepared by reacting a salt of an acrylamidoalkanesulfonic acid, also known as a sulfonate, with an amine. Alternatively a salt of an acrylic or alkylacrylic acid could be used. In lieu of the sulfonate one could use an acryamido alkanedisulfonic acid, a styrene sulfonate, phosphonate, phosphate, sulfate or a carboxylate wherein a PO₃(R^{d}), O—PO₃(R^{d}), O—SO₃ or CO₂ is substituted for the SO₃ in the formula shown below. The salt of this sulfonic acid can be represented by the formula

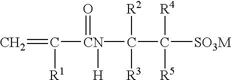

wherein R¹ is hydrogen, methyl or ethyl; R² is hydrogen or an alkyl group containing up to 18 carbon atoms; and each of R³, R⁴ and R⁵ is individually hydrogen or an alkyl group containing up to 7 carbon atoms or an alkanesulfonic acid of 1 to 4 carbon atoms. Examples of lower alkyl radicals are methyl, ethyl, n-propyl, isopropyl, 1-butyl, 2-butyl, 2-pentyl, 3-hexyl and 3-methylpentyl. Desirably, in one embodiment where the disulfonic acid is used R³ is methylene sulfonic acid. The M comprises an alkali metal, an alkaline earth metal or an amino compound.

The reaction to form the salt is a simple neutralization of an acrylamidoalkanesulfonic acid, usually with a metal base or amine comprising at least one metal oxide, metal hydroxide, metal salt of a weak acid such as carbonic, boric or acetic acid or amine. The neutralizing salt is most often a metal carbonate or bicarbonate, e.g., sodium carbonate or sodium bicarbonate. Also useful, in place of such salts, are cation exchange resins in the metal salt form (usually alkali metal and especially sodium), typically strong acid or weak acid resins in which the acid group may be, for example, sulfonic or carboxylic acid groups.

The preferred acids of acrylamidoalkane such as acrylamidoalkanesulfonic acids are those in which R⁴ and R⁵ are each hydrogen, R² is an alkyl group containing up to 7 carbon atoms and R³ is hydrogen or an alkyl group containing up to 7 carbon atoms, usually the latter. Illustrative acids are 2-acrylamidoethanesulfonic acid, 2-acrylamidopropanesulfonic acid, 2-acrylamido-2-methylpropanesulfonic acid, 2-methacrylamidopropanesulfonic acid, 2-methacrylamido-2-methylpropanesulfonic acid and 2-methacrylamido-2-methylbutanesulfonic acid. A particular preference is expressed for 2-acrylamido-2-methylpropanesulfonic acid, commercially available from The Lubrizol Corporation as AMPS® monomer and to a somewhat lesser extent for its methacrylamido homolog.

The cation of a preferred embodiment are metals and include, in particular, the alkali metal and alkaline earth metal salts, chiefly those of lithium, sodium, potassium, magnesium, calcium and barium, and especially those of sodium, potassium, magnesium and calcium. A most preferred metal is sodium. Such materials and their methods of preparation are disclosed, for instance, in U.S. Pat. No. 3,544,597.

The different types of amines are envisioned as reacting with the above-described sulfonate, sulfate, phosphate, phosphonate, and carboxylate. These amines are of the formula

R⁶R⁷NH or R⁸(NH₂)ₙ

wherein R⁶ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms, or R⁹NH(CH₂)₃— wherein R⁹ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms; R⁷ is —(CH₂)₃NH₂ or a hydrocarbyl of up to 30 carbon atoms wherein desirably the total carbons of R⁶ and R⁷ combined is at least 8 or 10; n is 1 or 2 and when n is 1, R⁸ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms and when n is 2, R⁸ is a hydrocarbylene group containing from 6 to 30

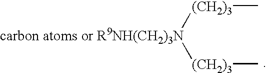

As used herein, the term “hydrocarbyl”, “hydrocarbyl substituent” or “hydrocarbyl group” is used in its ordinary sense, which is well known to those skilled in the art. Specifically, it refers to a group having a carbon atom directly attached to the remainder of the molecule and having predominantly hydrocarbon character. Examples of hydrocarbyl groups include:

(1) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule;

(2) substituted hydrocarbon substituents, that is, substituents containing non-hydrocarbon groups which, in the context of this invention, do not alter the predominantly hydrocarbon substituent (e.g., halo (especially chloro and fluoro), hydroxy, alkoxy, mercapto, alkylmercapto, nitro, nitroso, and sulfoxy);

(3) hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

The term “hydrocarbyl” is also intended to include hydrocarbylene, that is, groups having bonds to non-hydrocarbon functionality at two places, i.e., two open valences.

When the amine is R⁶R⁷NH wherein R⁶ is an aliphatic group wherein the aliphatic group contains from 6 to 30 carbon atoms and R⁷ is —(CH₂)₃NH₂, the amine that is generated has the structure C₆₋₃₀ aliphatic NH (CH₂)₃NH₂. This structure is N-aliphatic trimethylenediamine. Preferably, R⁶ contains up to 22 carbon atoms and most preferably R⁶ contains from 10 to 18 carbon atoms. These are the preferred amines of this invention and these amines are available from AKZO as Duomeen O™ amine, an N-oleyl-1,3-diaminopropane, Duomeen T™ amine, an N-tallow-1,3-diaminopropane, Duomeen C™ amine, an N-coco-1,3-diaminopropane and Duomeen S™ amine, an N-soya-1,3-diaminopropane.

When R⁶ is R⁹NH(CH₂)₃— wherein R⁹ is an aliphatic group containing from 6 to 30 carbon atoms and R⁷ is —(CH₂)₃NH₂, the amine that is generated has the structure C₆₋₃₀ aliphatic NH(CH₂)₃NH(CH₂)₃NH₂. This structure is N-aliphatic dipropylenetriamine. Preferably R⁹ contains up to 22 carbon atoms and most preferably contains from 10 to 18 carbon atoms. This amine is available from AKZO as Trimeen T™ amine.

When the amine is R⁸(NH₂)ₙ wherein R⁸ is an aliphatic group containing from 6 to 30 carbon atoms and n is 1, the amine structure is C₆₋₃₀ aliphatic NH₂ which defines fatty amines. Preferably R⁸ is an alkyl group and contains up to 22 carbon atoms and most preferably contains from 8 to 18 carbon atoms. A non-exhaustive, but exemplary list of fatty amines are hexylamine, heptylamine, octylamine, 2-ethylhexylamine, nonylamine, decylamine, undecylamine, dodecylamine, tridecylamine, tetradecylamine, pentadecylamine, hexadecylamine, heptadecylamine, octadecylamine, oleylamine, etc.

When n is 2, R⁸ is a hydrocarbylene group, specifically an alkylene group containing from 6 to 30 carbon atoms, preferably up to 22 carbon atoms and most preferably up to 18 carbon atoms. The di-primary amine may be a straight chain di-primary amine and the amino groups may both be terminal, one terminal and one internal or both internal such as 1,6-diaminohexane; 1,5-diaminohexane and 2,5-diaminohexane, respectively. R⁸ may be branched as in 2-methyl-1,5-pentanediamine. Additionally, when n is 2, R⁸ is

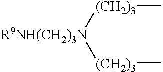

wherein R⁹ is as defined above. The amine that is generated is a tetraamine of the

formula

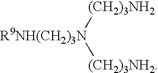

In preparing one embodiment of the surfactant, the amine and salt of the acid e.g. acrylamidoalkanesulfonic acid, are reacted together. Alternatively to the acrylamidoalkanesulfonic acid an acrylamidoalkanephosphonic acid or the phosphate, sulfate or carboxylate could be used. The acrylamidoalkanephosphonic acids are generally available only as experimental materials. The reaction is an addition reaction. The amine adds across the carbon-carbon double bond. The amine contains amine reactive hydrogens and each amine reactive hydrogen is capable of reacting with one mole of the salt of the acrylamidoalkanesulfonic acid. One mole of a primary amine which contains 2 amine reactive hydrogens will react with up to 2 moles of the salt of the acrylamidoalkanesulfonic acid. In the case of the Duomeen™ amines, one mole, which contains 3 amine reactive hydrogens, will react with up to 3 moles of the salt of the acrylamidoalkanesulfonic acid. The di-primary amines and the Trimeen™ amine each contain 4 amine reactive hydrogens and 1 mole of these amines will react with up to 4 moles of the metal salt. This defines the upper limit of the number of moles of the salt that can be reacted with one mole of any of the amines of this invention. When 1 mole of any of these amines is used, at least one mole of salt is employed, regardless of the number of amine reactive hydrogens that are present.

As examples of the various products that can be obtained, the following shows the reaction of one mole of a Duomeen™ amine with from 1 to 3 moles of a sodium salt of 2-acrylamido-2-methylpropanesulfonic acid.

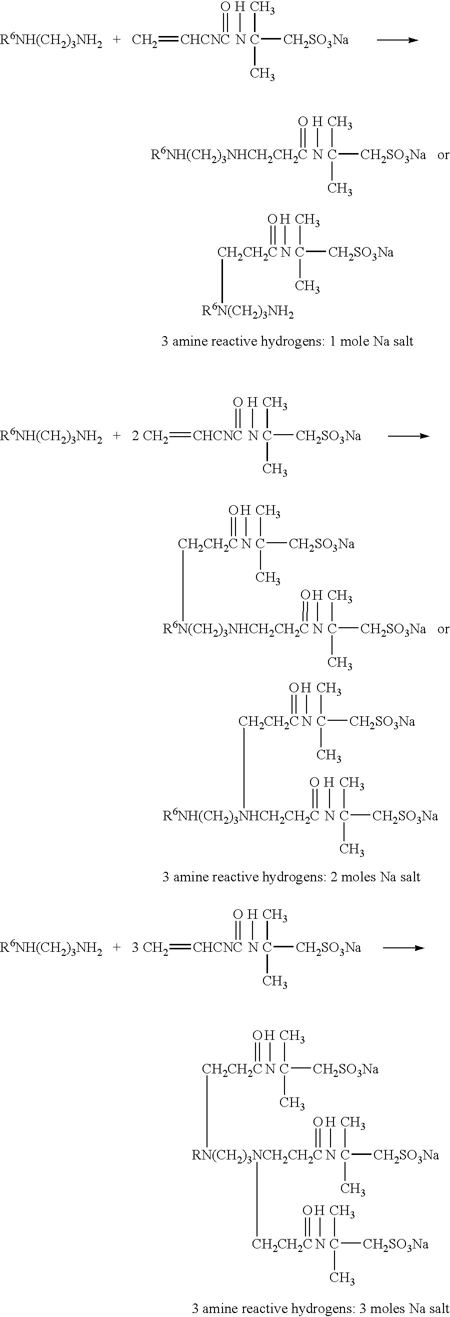

The following shows the reaction of one mole of a mono primary amine with from 1 to 2 moles of a sodium salt of 2-acrylamido-2-methylpropanesulfonic acid.

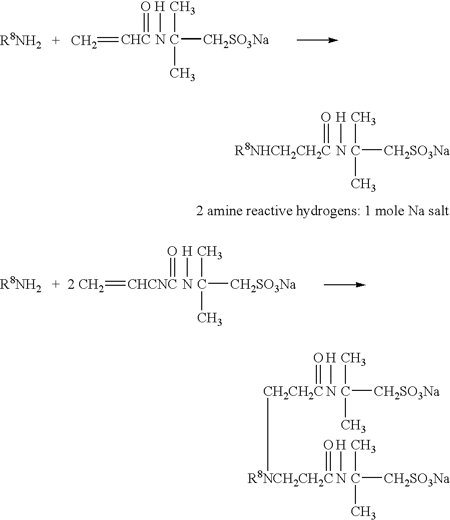

2 amine reactive hydrogens: 2 moles Na salt

Suitable conditions leading to the controlled degree of reaction characteristic of the present invention include combining the amine with an appropriate amount of the salt of acrylamidoalkanesulfonic acid (or acryamidoalkanephosphonic acid) in a suitable solvent (such as water and/or alcohols) at a temperature of 40 to 130° C., preferably 70 to 100° C. for 4 to 30 hours. The total concentration of the reactants can be 1 to 50% by weight, preferably 5 to 30% by weight. Optionally, a free radical inhibitor such as monomethyloxyhydroquinone can be used at a suitable concentration such as about 1000 parts per million.

The above-described surfactant is used in water or other solvents, generally at a concentration of 0.005 to 5 weight percent, preferably 0.25 to 3 percent and more preferably 2 to 3 percent (based on active chemical, exclusive of diluent water or solvents). The amounts can be adjusted, as needed, to optimize performance for a particular combination of soil and contaminant. For in situ remediation, concentrations of 1 to 3 weight percent are sometimes preferred; for ex situ remediation (where soil is removed from the ground and treated), concentrations of 0.01 to 0.5 weight percent are sometimes preferred. The surfactant can be dissolved or otherwise dispersed in the water; preferably the sufactant is dissolved.

Alternatively to the reaction product of an amine with the salt of sulfonic acid given above the following generic emulsifiers could be used under the same conditions

R^{b}—N(H)—R^{a}—SO₃⁻M⁺

R^{b}—N(H)—R^{a}—(SO₃^{-M}⁺)₂

R^{b}—N(H)—R^{a}—SO₃^{-M}⁺

R^{b}—N(H)—R^{a}—PO₃(R^{d})⁻M⁺

R^{b}—N(H)—R^{a}—O—PO₃(R^{d})⁻M⁺

R^{b}—N(H)—R^{a}—CO₂⁻M⁺

R^{c}—(R^{b})—N(H)—R^{a}—SO₃^{-M}⁺

R^{c}−(R^{b})—N(H)—R^{a}O—SO₃^{-M}⁺

R^{c}—(R^{b})—N(H)—R^{a}—PO₃(R^{d})⁻M⁺

R^{c}—(R^{b})—N(H)—R^{a}—O—PO₃(R^{d})⁻M⁺or

R^{c}—(R^{b})—N(H)—R^{a}—CO₂^{-M}⁺

where R^{a} is a hydrocarbyl group of up to 15 carbon atoms optionally including branching and/or aromatic groups and optionally including heteroatoms of oxygen and nitrogen such as an amide linkage, where R^{b} and R^{c} independently are hydrocarbyl (preferably hydrocarbon) groups of up to 50 carbon atoms including branching, aromatic groups and optionally —R^{a}—SO₃⁻M⁺, —R^{a}—O—SO₃⁻M⁺, R^{a}—PO₃(R^{d})—M⁺, R^{a}—O—PO₃(R^{d})⁻M⁺, or —R^{a}—CO₂⁻M⁺ and optionally including heteroatoms such as oxygen, nitrogen, sulfur, and phosphorus, and R^{d} is H or a lower alkyl of 1 to 4 carbon atoms.

If desired, one or more additional surfactants, preferably in amounts within the ranges set forth above, can be used along with the above-described materials. Common surfactants can be characterized as non-ionic, anionic, cationic, or amphoteric. Non-ionic surfactants include nonylphenol (POE5), octylphenol (POE5), lauryl alcohol (POE5), octadecyl alcohol (POE5), sorbitan monooleate, sorbitan monooleate (POE5), glycerol monooleate, lauryl alcohol polyglycoside, oleicdiethanolamide, oleylhydroxymethyl imidazoline, oleylamine (POE5), oleyl dimethylamine oxide, poly(ethylene oxide [m.w. 400]) dioleate, and poly(ethylene oxide) 14 oleate.

Anionic surfactants include sodium laurate, sodium xylene sulfonate, sodium dodecylbenzene sulfonate, sodium monomethylnaphthalene sulfonate, sodium dimethylnaphthalene sulfonate, dioctyl sodium sulfosuccinate, sodium hexadecyl sulfonate, dodecyldiphenyloxide disulfonate (disodium salt), hexadecyldiphenyloxide disulfonate (disodium salt), sodium decyl sulfate, sodium lauryl (POE2) sulfate, nonylphenol (POE2) sulfate (sodium salt), sodium N-methyl-N-oleoyl taurate, sodium di-2-ethylhexyl phosphate, sodium cocyl isethionate, and sodium lauryl (POE13) acetate.

Cationic surfactants include benzyl trimethylammonium bromide and cetyl pyridinium chloride. Amphoteric surfactants include lecithin and lauryldimethyl-hydroxypropylsulfobetaine.

In the foregoing materials, the expression “POEn” indicates an ethylene oxide oligomer containing n repeat units, attached by an ether linkage through an alcoholic or phenolic oxygen atom of the remainder of the molecule.

The surfactant-water combination is used to contact the contaminated soil and to remove organic contaminants therefrom by mechanical techniques which are known to those skilled in the art. Using a process based on the conventional “pump and treat” procedure, the aqueous composition can be injected into the ground at or near a site of contamination, and a water composition, comprising the surfactant and a portion of the contaminants, can be pumped out from the ground in such a way that the water/surfactant composition has traversed at least a portion of the contaminated soil. The aqueous composition thereby recovered can be treated for waste processing and management. Such treatment can consist of separation of the contaminant from the water and surfactant by known means such as air stripping, foam fractionation, distillation, coagulation, solidification, filtration, or other such techniques, and subsequent disposal of the contaminant, for example, by combustion. It is also possible to recover some or all of the surfactant for reuse, if desired.

Alternatively, a portion of contaminated soil can be removed from the ground and treated with a suitable aqueous solution of surfactant in an appropriate apparatus. The soil can be contacted with the surfactant solution by stirring or slurrying in a batch-type operation, or by passing the solution through the soil in a continuous fashion. The aqueous solution, containing a portion of the organic contaminant, can be separated from the soil by known methods such as filtration, decantation, or centrifugation. Remediation by removal of the soil and treatment in this manner is particularly suitable for small and localized areas of contamination or for spot testing and evaluation purposes.

In yet another approach, the surfactants of the present invention can be used in surfactant-assisted bioremediation processes, that is, a process in which the decontamination is effected by a surfactant-assisted biological process. In such processes, it is speculated that the surfactant may serve to “loosen” the contaminant from the soil particles and make it more readily available for decontamination. The contamination itself is effected, optionally in situ, by biological processes resulting from, for instance, the action of bacteria or other organisms, whether organisms naturally occurring (naturally present in the soil) or selected or designed for the purpose of decontamination. In this embodiment, physical removal of the aqueous compositions and organic chemicals associated therewith from the soil may not be necessary.

It is known that some of the materials described above may interact in the final formulation, so that the components of the final formulation may be different from those that are initially added. For instance, metal ions (of e.g., a detergent) can migrate to other acidic sites of other molecules. The products formed thereby, including the products formed upon employing the surfactant of this invention in its intended use, may not be susceptible of easy description. Nevertheless, all such modifications and reaction products are included within the scope of the present invention.

The following examples are illustrative of the preparation of the emulsifiers of this invention along with the making and breaking of emulsions by protonating an amine group on the emulsifier. Unless otherwise indicated, all parts and percentages are by weight.

### EXAMPLE 1

### Preparation of 1^{st} Emulsifier

### (3 Amine Reactive Hydrogens/2 Moles Na Salt)

Added to a 2 liter 4 neck flask equipped with a stirrer and thermowell is 500 parts methanol, 568.4 parts (1.44 moles) of a 42% aqueous solution of the sodium salt of 2-acrylamido-2-methylpropanesulfonic acid and 186 parts (0.72 moles) of Duomeen C™ amine (an N-coco-1,3-diaminopropane). The mixture is stirred and heated to reflux at about 75° C. Reflux conditions are maintained for 30 hours. At the conclusion of the heating time, methanol and water are removed from the reaction mixture using a vacuum oven while maintaining the temperature below 100° C. The product is 431 parts of a yellowish solid.

### EXAMPLE 2

### Emulsion Formation and Recycling of Emulsifier and Water

The emulsifier of Example 1 was dissolved at a 4% by weight concentration in water. In addition to the surfactant; 6% isopropyl alcohol, 0.3% calcium chloride, and 3.5% sodium chloride are added the surfactant to modify it's emulsion forming capabilities. To simulate in-situ or ex-situ soil remediation of a typically contaminant; 15 ml of the aqueous solution was contacted with an equal volume of 1,1,1-trichloroethane. The mixture was mixed vigorously with the aid of a mechanical wrist action shaker and the mixed again using a tube vortex unit at high speed. The resulting emulsion (a Winsor I type) was formed. The emulsion was allowed to stand for 96 hours to check the stability. No change was observed during this period.

At the end of this period the emulsion was titrated from a pH of 10.5 to a pH of 3.0. using 2 molar hydrochloric acid. The aqueous phase and 1,1,1-trichloroethane began to separate into distinct layers. A middle layer also formed. The mixture was then centrifuged at high speed for 1.5 hours. Two distinct layers formed with a small emulsion cuff between them. Based on a mass balance, 95% to 99% of the aqueous phase was recovered. The resultant aqueous phase was then adjusted to pH 10. An equal volume of virgin 1,1,1-trichloroethane was added. And again the mixture was mixed vigorously with the aid of a mechanical wrist action shaker and then mixed again using a tube vortex unit at high speed. The resulting emulsion (a Winsor I type) was formed.

### EXAMPLE 3

### Preparation of 2^{nd} Emulsifier

### (3 Amine Reactive Hydrogens/2 Moles Na Salt)

To a 500 ml flask are added 39.5 (0.1 moles) parts of a 42% aqueous solution of the sodium salt of 2-acrylamido-2-methylpropanesulfonic acid, 17.7 parts (0.05 moles) of Duomeen T™ amine (an N-tallow-1,3-diaminopropane), 350 parts water and 0.1 part hydroquinone monomethoxy ether as an inhibitor. The mixture is stirred at 95° C. for 16 hours. At the end of this time, a homogeneous solution results. The water is removed from the mixture as in Example 1, leaving a dull orange solid product that is water soluble.

### EXAMPLE 4

### Emulsion Formation and Recycling of Emulsifier and Water

The emulsifier of Example 3 was dissolved at a 4% by weight concentration in water. In addition to the surfactant; 4% isopropyl alcohol, 0.25% calcium chloride, and 3.5% sodium chloride are added the surfactant to modify it's emulsion forming capabilities. To simulate in-situ or ex-situ soil remediation of a typically contaminant; 15 ml of the aqueous solution was contacted with an equal volume of trichloroethylene. The mixture was mixed vigorously with the aid of a mechanical wrist action shaker and then mixed again using a tube vortex unit at high speed. The resulting emulsion (a Winsor I type) was formed. The emulsion was allowed to stand for 144 hours to check the stability. Approximately 1 to 2 ml of the aqueous solution (top) and trichloroethylene (bottom) did separate from the emulsion phase during this period.

At the end of this period the entire emulsion mixture was titrated from a pH of 11.4 to a pH of 3.0. using 2 molar hydrochloric acid. The aqueous phase and trichloroethylene began to separate into distinct layers. A middle layer also formed. The mixture was then centrifuged at high speed for 2 hours. Two distinct layers formed with a small emulsion cuff between them. Based on a mass balance, greater than 92% of the aqueous phase was recovered.

The resultant aqueous phase was then adjusted to pH 10.5. An equal volume of virgin trichloroethylene was added. And again the mixture was mixed vigorously with the aid of a mechanical wrist action shaker and the mixed again using a tube vortex unit at high speed. The resulting emulsion (a Winsor I type) was formed.

General Summary

The selection of surfactants and formulation variables used for soil remediation are a function of site-specific geology and available natural water. The soil contaminants also govern the selection process. All of the chemistry taught here and in a related application case 2974 (U.S. application Ser. No. 09/418,346) is suitable for the remediation of a wide range of non-aqueous phase liquids and other dispersible compounds. The selection of the surfactant can also include a mixture of the chemistries described or the addition of some commercial co-surfactants. The addition of optional phase modifiers, C2 through C5 alcohols (0.1 to 16 or 20 wt. %), calcium salts (0.1 to 5 wt. %), magnesium salts (0.1 to wt.5%) and sodium salts (0.1 to 12 or 15 wt. %), with the salts typically being chlorides, and the concentration of the surfactant will vary with site and contaminant variation.

The process of separation of the used surfactant stream from the contaminant is common thread throughout all these variations, provided the phase behavior of at least one of the surfactants is modified by the process of changing the pH, either acid to base or basic to acid and with the majority of the surfactant remaining in the aqueous phase. After separation, the surfactant phase can be re-generated by adjusting the pH back to its original value thus allowing for the reuse of the surfactant. Even if the surfactant is not reused the ease of separation or the organic and aqueous phases compared to conventional mechanical means is superior and allows for a very large reduction of the amount of remediated soil contaminant requiring disposal.

While the invention has been explained in relation to its preferred embodiments, it is to be understood that various modifications thereof will become apparent to those skilled in the art upon reading the disclosure. Therefore, it is to be understood that the invention disclosed herein is intended to cover such modifications as fall within the scope of the appended claims.

What is claimed is:

1. A method for recycling the emulsifier and water from an emulsion of water with at least one hydrophobic organic compound comprising;
a) first selecting an emulsion made with an emulsifier having at least one protonatable amine in the emulsifier, a hydrophobic organic compound, and water;
b) then acidifying the emulsion to protonate said amine (which changes the HLB of said emulsifier, increases the water solubility of said emulsifier, and promotes the breaking of said emulsion);
c) then isolating at least 50 weight percent of said organic compound from the water and emulsifier,
d) then readjusting the pH of said water and emulsifier to regenerate the non-protonated emulsifier; and
e) finally contacting said water and emulsifier from step d) with a hydrophobic organic compound to regenerate an emulsion.

2. The process of claim 1, wherein said emulsifier includes a hydrophilic portion which comprises a salt of a sulfonic, sulfuric, carboxylic, phosphonic, or phosphoric acid.

3. The process of claim 2 wherein said emulsifier has the formula
R^{b}—N(H)—R^{a}—SO₃⁻M⁺
R^{b}—N(H)—R^{a}—(SO₃⁻M⁺)₂
R^{b}—N(H)—R^{a}O—SO₃⁻M⁺
R^{b}—N(H)—R^{a}—PO₃(R^{d})⁻M⁺
R^{b}—N(H)—R^{a}—O—PO₃(R^{d})⁻M⁺
R^{b}—N(H)—R^{a}—CO₂⁻M⁺
R^{c}—(R^{b})—N(H)—R^{a}—SO₃⁻M⁺
R^{c}—(R^{b})—N(H)—R^{a}O—SO₃⁻M⁺
R^{c}—(R^{b})—N(H)—R^{a}PO₃(R^{d})⁻M⁺
R^{c}—(R^{b})—N(H)—R^{a}—PO₃(R^{d})⁻M⁺ or
R^{c}—(R^{b})—N(H)—R^{a}—CO₂⁻M⁺
where R^{a} is a hydrocarbyl group of up to 15 carbon atoms optionally including branching and/or aromatic groups and optionally including heteroatoms of oxygen and nitrogen such as an amide linkage, where R^{b} and R^{c} independently are hydrocarbon groups of up to 50 carbon atoms including branching, aromatic groups and optionally —R^{a}—SO₃⁻M⁺, —R^{a}—O—SO₃⁻M⁺, R^{a}—PO₃(R^{d})⁻M⁺, R^{a}—O—PO₃(R^{d})⁻M⁺, or —R^{a}—CO₂⁻M⁺ and optionally including heteroatoms such as oxygen, nitrogen, sulfur, and phosphorus, and R^{d} is H, M, or a lower alkyl of 1 to 4 carbon atoms.

4. The process of claim 2 wherein said emulsifier is characterized as the reaction product of 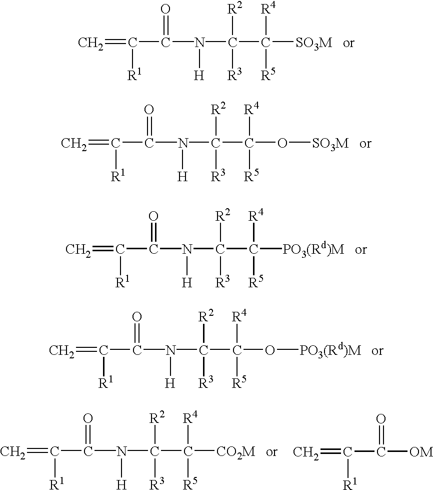
with an amine of the formula
R⁶R⁷NH or R⁸(NH₂)ₙ
wherein R¹ is hydrogen or a lower alkyl of 1 to 4 carbon atoms, R² is hydrogen or an alkyl group containing up to 18 carbon atoms, and each of R³, R⁴ and R⁵ is individually hydrogen, an alkyl group containing up to 7 carbon atoms, or an alkylene sulfonate of 1 to 4 carbon atoms and M is H or an alkali metal, an alkaline earth metal or —NR¹⁰R¹¹R¹² wherein R¹⁰, R¹¹ and R¹² are independently hydrogen or hydrocarbyl groups containing from 1 to 22 carbon atoms, and R^{d} is H or an alkyl of 1 to 4 carbon atoms, wherein R⁶ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms, or R⁹NH(CH₂)₃— wherein R⁹ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms; R⁷ is —(CH₂)₃NH₂ or a hydrocarbyl group of up to 30 carbon atoms wherein the total carbons of R⁶ and R⁷ combined are at least 8; n is 1 or 2 and when n is 1, R⁸ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms and when n is 2, R⁸ is a hydrocarbylene group containing from 6 to 30
or 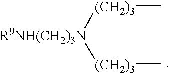
carbon atoms

5. A process according to claim 1, 2, 3, or 4 wherein the original emulsion contains a hydrophobic organic chemical extracted during soil remediation, and wherein the water and emulsifier separated from said hydrophobic organic chemical is put in contact with contaminated soil to extract a hydrophobic organic chemical from a contaminated soil.

6. A process according to claim 5, wherein the hydrophobic organic chemical comprises a lubricant, a fuel, a solvent, a heat transfer fluid, a transformer fluid, crude oil, or combinations thereof.

7. A process according to claim 5, wherein the hydrophobic organic chemical comprises a chlorinated hydrocarbon.

8. A process according to claim 4, wherein R⁴ and R⁵ are each hydrogen.

9. A process according to claim 4 or 5, wherein R¹, R², and R³ is each independently hydrogen or a linear or branched alkyl of 1 to 4 carbon atoms.

10. A process according to claim 4 or 5, wherein the amine is R⁶R⁷NH wherein R⁶ is a hydrocarbyl group comprising an aliphatic group containing up to 22 carbon atoms and R⁷ is —(CH₂)₃—NH₂.

11. A process according to claim 10, wherein said amine is reacted with the salt of a sulfonic acid and R⁶ contains from 10 to 18 carbon atoms.

12. A process according to claim 4 or 5, wherein the amine is R⁶R⁷NH wherein R⁶ is R⁹NH(CH₂)₃— wherein R⁹ is a hydrocarbyl group comprising an aliphatic group containing up to 22 carbon atoms.

13. A process according to claim 4 or 5, wherein the amine is R⁸(NH₂) and R⁸ is a hydrocarbyl group comprising an alkyl group containing up to 22 carbon atoms.

14. A process according to claim 5, wherein the emulsion is formed from a soil contaminant and the recycled water and emulsifier is used to remove additional contaminants from soil via an extraction technique.

15. A method of remediating soil which is contaminated with one or more hydrophobic organic chemicals, comprising:
contacting the contaminated soil with an aqueous composition comprising a surfactant prepared by reacting a compound of the formula 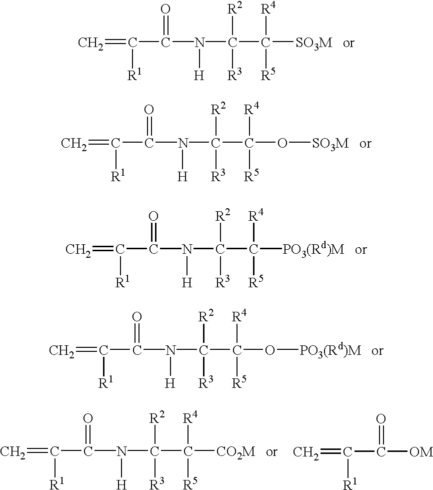
with an amine of the formula R⁶R⁷NH or R⁸(NH₂)ₙ.
wherein R¹ is hydrogen, methyl, or ethyl; R² is hydrogen or an alkyl group containing up to 18 carbon atoms; and each of R³ R⁴ and R⁵ is individually hydrogen, an alkyl group containing up to 7 carbon atoms or an alkylene sulfonate of 1 to 4 carbon atoms; M is an alkali metal, an alkaline earth metal or —NR¹⁰R¹¹R¹² wherein R¹⁰, R¹¹ and R¹² are independently hydrogen or hydrocarbyl groups containing from 1 to 22 carbon atoms; and R^{d} is H, M, or a lower alkyl of 1 to 4 carbon atoms,
wherein R⁶ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms, or R⁹NH(CH₂)₃— wherein R⁹ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms; R⁷ is —(CH₂)₃NH₂ or a hydrocarbyl group of up to 30 carbon atoms wherein the total carbons of R⁶ and R⁷ combined are at least 8; n is 1 or 2 and when n is 1, R⁸ comprises a hydrocarbyl group, a hydroxyhydrocarbyl group, an alkoxyhydrocarbyl group wherein up to 12 carbon atoms are in the alkoxy group or an aminohydrocarbyl group, wherein the hydrocarbyl group contains from 6 to 30 carbon atoms and when n is 2, R⁸ is a hydrocarbylene group containing from 6 to 30 carbon atoms or 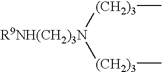
whereby at least a portion of said hydrophobic organic chemical becomes associated with said aqueous composition including sequential steps of isolating said aqueous composition after it has become associated with said hydrophobic organic chemical, acidifying said aqueous composition to protonate the amine in said surfactant, separating the hydrophobic organic chemical from said aqueous composition, thereafter readjusting the pH to de-protonate said amine, and thereafter contacting the contaminated soil with the aqueous composition recovered after acidification.

16. The method of claim 15 wherein the hydrophobic organic chemical comprises a lubricant, a fuel, a solvent, a heat transfer fluid, a transformer fluid, crude oil, or combinations thereof.

17. The method of claim 15 wherein the hydrophobic organic chemical comprises a chlorinated hydrocarbon.

18. The method of claim 15 wherein R⁴ and R⁵ are each hydrogen.

19. The method of claim 15 wherein R¹, R² and R³ is each independently a hydrogen or a linear or branched alkyl of 1 to 4 carbon atoms.

20. The method according to claim 15, wherein the amine is R⁶R⁷NH wherein R⁶ is a hydrocarbyl group comprising an aliphatic group containing up to 22 carbon atoms and R⁷ is —(CH₂)₃—NH₂.

21. The method according to claim 20, wherein said amine is reacted with the salt of a sulfonic acid and R⁶ contains from 10 to 18 carbon atoms.

22. The method according to claim 15, wherein the amine is R⁶R⁷NH wherein R⁶ is R⁹NH(CH₂)₃— wherein R⁹ is a hydrocarbyl group comprising an aliphatic group containing up to 22 carbon atoms.

23. The method according to claim 15, wherein the amine is R⁸(NH₂)ₙ and R⁸ is a hydrocarbyl group comprising an alkyl group containing up to 22 carbon atoms.

24. The method according to claim 15, wherein said aqueous composition further includes from about 0.1 to about 15 wt. % NaCl or from about 0.1 to about 5 wt. % of CaCl₂ or MgCl₂.

25. The method according to claim 15, wherein said aqueous composition further includes from about 0.1 to about 20 weight percent of an alcohol having from 2 to 5 carbon atoms.

26. The method of claim 15, where said aqueous composition further includes on or more detergent builders.

27. A method of remediating soil which is contaminated with one or more hydrophobic organic chemicals, comprising:
contacting the contaminated soil with an aqueous composition comprising a surfactant of the formula
R^{b}—N(H)—R^{a}—SO₃⁻M⁺
R^{b}—N(H)—R^{a}—(SO₃⁻M⁺)₂
R^{b}—N(H)—R^{a}O—SO₃⁻M⁺
R^{b}—N(H)—R^{a}—PO₃(R^{d})⁻M⁺
R^{b}—N(H)—R^{a}—O—PO₃(R^{d})⁻M⁺
R^{b}—N(H)—R^{a}—CO₂⁻M⁺
R^{c}—(R^{b})—N(H)—R^{a}—SO₃⁻M⁺
R^{c}—(R^{b})—N(H)—R^{a}O—SO₃⁻M⁺
R^{c}—(R^{b})—N(H)—R^{a}—PO₃(R^{d})⁻M⁺
R^{c}—(R^{b})—N(H)—R^{a}—O—PO₃(R^{d})—M⁺ or
R^{c}—(R^{b})—N(H)—R^{a}—CO₂⁻M⁺
where R^{a} is a hydrocarbyl group of up to 15 carbon atoms optionally including branching and/or aromatic groups and optionally including heteroatoms of oxygen and nitrogen such as an amide linkage, where R^{b} and R^{c} independently are hydrocarbon groups of up to 50 carbon atoms including branching, aromatic groups and optionally —R^{a}—SO₃⁻M⁺, —R^{a}—O—SO₃⁻M⁺, R^{a}—PO₃(R^{d})⁻M⁺, R^{a}—O—PO₃(R^{d})⁻M⁺, or —R^{a}—CO₂⁻M⁺ and optionally including heteroatoms such as oxygen, nitrogen, sulfur, and phosphorus, and R^{d} is H or a lower alkyl of 1 to 4 carbon atoms, whereby at least a portion of said hydrophobic organic chemical becomes associated with said aqueous composition including sequential steps of isolating said aqueous composition after it has become associated with said hydrophobic organic chemical, acidifying said aqueous composition to protonate the amine in said surfactant, separating the hydrophobic organic chemical from said aqueous composition, thereafter readjusting the pH to de-protonate said amine, and thereafter contacting the contaminated soil with the aqueous composition recovered after acidification.
